(19) United States
(12) Patent Application Publication
(10) Pub. No.: US 2012/0194329 A1
(43) Pub. Date: Aug. 2, 2012

(54) SOUND WAVE GENERATOR

(75) Inventors: Toshiaki Nakayama, Miyoshi-city (JP); Toshio Hayashi, Obu-city (JP); Kouji Sakurai, Chita-gun (JP)

(73) Assignee: DENSO CORPORATION, Kariya-city (JP)

(21) Appl. No.: 13/359,811

(22) Filed: Jan. 27, 2012

(30) Foreign Application Priority Data
Jan. 31, 2011 (JP) 2011-17961

(51) Int. Cl. B60Q 1/00; H04R 19/02

(52) U.S. Cl. 340/425.5; 381/191

(57) ABSTRACT

A sound wave generator includes a speaker control circuit and a speaker. The speaker control circuit includes a signal generating unit that is configured to generate an electric signal having a humming frequency property. The humming frequency property includes a plurality of frequencies that have an overtone relationship with respect to A Hz and are pitched at the A Hz, the A Hz being a target generation frequency and corresponding to a low pitch frequency in an audible range. The speaker generates a sound wave from the electric signal by applying the electric signal to a vibration plate that produces the sound wave.

### CROSS REFERENCE TO RELATED APPLICATION

This application is based on Japanese Patent Application No. 2011-17961 filed on Jan. 31, 2011, the disclosure of which is incorporated herein by reference.

### FIELD OF THE INVENTION

The present invention relates to a sound wave generator.

### BACKGROUND OF THE INVENTION

In general, a speaker having a large diaphragm, such as a woofer, is used to generate a low pitch sound. However, if there are any restrictions to loading and costs, it is difficult to employ such a speaker having a large diaphragm. On the other hand, in a sound wave generator having a small speaker (microspeaker), it is difficult to create a low pitch sound. Therefore, only a sound having less low pitch tone is generated.

A sound wave generator is for example used for a vehicle approach notification apparatus for notifying a presence of a vehicle whose traveling sound is small, such as an electric vehicle, a fuel cell vehicle and a hybrid vehicle. The above drawbacks will be explained with regard to a case of a vehicle approach notification apparatus that generates a notification sound to notify a presence of the vehicle of a human such as a pedestrian, as an example. For example, JP2005-289175A describes a vehicle approach notification apparatus that generates the notification sound using a dynamic speaker.

Although various sound wave signals, such as a single sound, a chord sound, a music sound, a voice sound, and a pseudo engine sound, are considered as the notification sound, it is desired to include a low pitch sound of 400 Hz or less in the notification sound so as to deepen the sound and improve comfort to hear.

FIG. 7 illustrates a frequency characteristic of a real engine sound. As shown in FIG. 7, the real engine sound includes a low pitch sound of 400 Hz or less. When a pseudo engine sound is generated as the notification sound, it is desired that the pseudo engine sound is similar to the real engine sound in an audible range.

In fact, it is difficult to employ a large speaker such as a woofer as the speaker for emitting the notification sound to an area outside of a vehicle due to the restriction to loading. On the other hand, if a small speaker (microspeaker) is employed to generate the pseudo engine sound, it is difficult to include the low pitch sound having frequency of 400 Hz or less. That is, in the vehicle approach notification apparatus, it is difficult to employ the large speaker due to the restriction to loading and thus it is difficult to generate the notification sound including the low pitch sound.

### SUMMARY OF THE INVENTION

It is an object of the present invention to provide a sound wave generator capable of generating a low pitch sound without requiring a large speaker.

According to an aspect, a sound wave generator includes a speaker control circuit and a speaker. The speaker control circuit includes a signal generating unit that is configured to generate an electric signal having a humming frequency property. The humming frequency property includes a plurality of frequencies that have an overtone relationship with respect to A Hz and are pitched at the A Hz, the A Hz being a target generation frequency and corresponding to a low pitch frequency in an audible range. The speaker generates a sound wave from the electric signal by applying the electric signal to a vibration plate that produces the sound wave.

In such a structure, when the speaker is driven by the electric signal having the humming frequency property, the generated sound wave varies with respect to a time axis. That is, the generated sound wave has a periodic property of harmonic at the A Hz. As a result, the target generation frequency of the A Hz is heard as a humming sound.

In other words, the target generation frequency of the A Hz, which cannot be mechanically produced by the speaker, can be heard due to the humming sound as if the target generation frequency is actually generated by the speaker. Accordingly, the low pitch frequency, which is lower than a generation capability of the speaker, can be generated, and thus the low pitch sound can be generated without using a large speaker such as a woofer.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a diagram for explaining a humming frequency property of a frequency signal generated by a sound wave generator according to a first embodiment;

FIG. 2 is a time chart illustrating a humming sound produced by the sound wave generator according to the first embodiment;

FIG. 3 is a schematic diagram of a vehicle approach notification apparatus employing the sound wave generator according to the first embodiment;

FIGS. 4A and 4B are cross-sectional views of vehicular horns as examples of a speaker of the sound wave generator according to the first embodiment;

FIG. 5 is a diagram for explaining a humming frequency property of a frequency signal generated in a sound wave generator according to a second embodiment;

FIG. 6 is a diagram for explaining a frequency characteristic of a sound produced by applying a frequency signal according to the second embodiment; and

FIG. 7 is a diagram illustrating a frequency characteristic of a real engine sound.

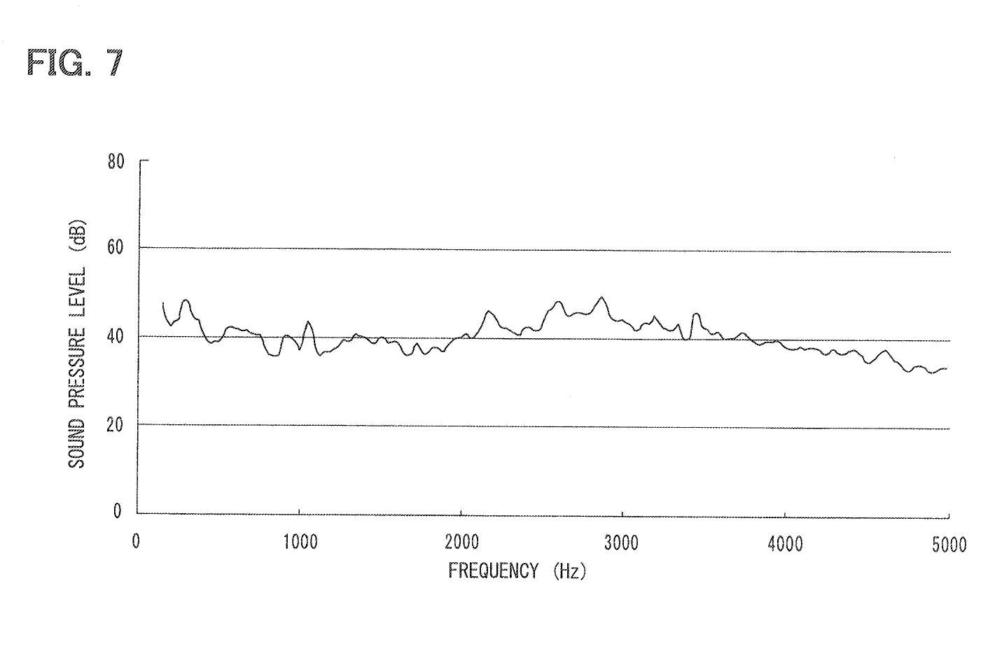

### DETAILED DESCRIPTION OF EXEMPLARY EMBODIMENTS

Exemplary embodiments will be described with reference to the drawings.

A sound wave generator is a device that converts an electric signal into a sound wave signal. The sound wave generator generally includes a speaker 2 that produces a sound wave from an electric signal by applying the electric signal to a vibration plate (diaphragm) that produces the sound wave; and a speaker control circuit 4 that includes a signal generating unit 3 that generates “a frequency signal” as the electric signal for vibrating the vibration plate 1.

In the sound wave generator according to the present embodiment, the signal generating unit 3 generates “the frequency signal (electric signal)” having a humming frequency property that includes “multiple frequencies (multiple humming frequencies)”, and “the multiple humming frequencies” have the overtone relationship with respect to an A Hz and pitched at the A Hz. The A Hz is a “target sound generation frequency” and is a low pitch frequency in an audible range.

For the purpose of better understanding, for example, “the multiple humming frequencies” are provided by A Hz×2, A Hz×3, and A Hz×4 . . . etc. The number of “the multiple humming frequencies” is not particularly limited, but a humming property of the sound produced by “the frequency signal” is noticeable with an increase in the number of “the multiple humming frequencies”.

Hereinafter, exemplary embodiments of the sound wave generator will be described in detail with reference to the drawings. In the exemplary embodiments, the sound wave generator is exemplarily employed to a vehicle approach notification apparatus.

### First Embodiment

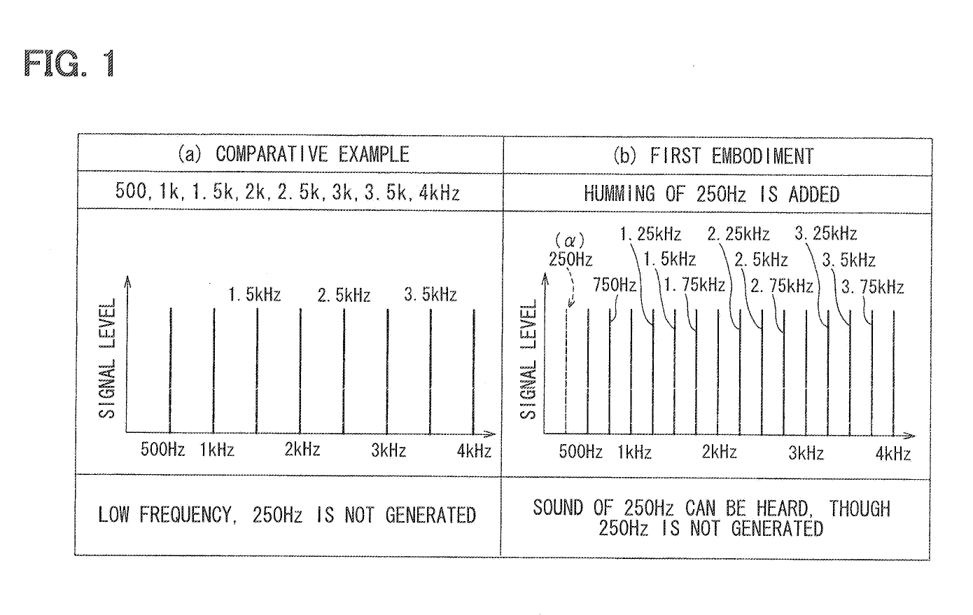

A first embodiment will be described with reference to FIGS. 1 through 4B.

The vehicle approach notification apparatus is typically mounted in a vehicle that is driven by an electric motor and whose traveling sound is small. For example, the vehicle approach notification apparatus is mounted in an electric vehicle, a hybrid vehicle and the like. The vehicle approach notification apparatus emits a notification sound to an area outside of the vehicle depending on a traveling condition or when a sensor detects a human such as a pedestrian, thereby to notify a presence of the vehicle to a periphery of the vehicle.

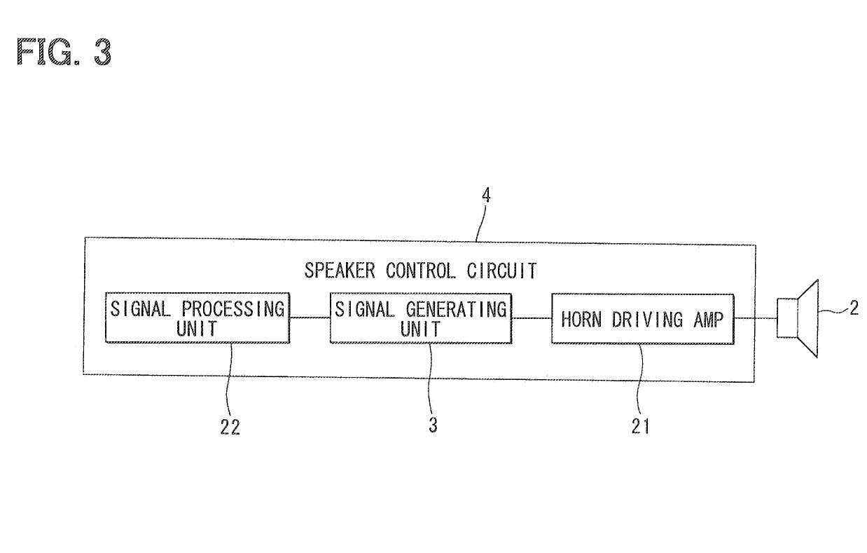

As shown in FIG. 3, the vehicle notification apparatus includes a vehicular horn 2 used as a dynamic speaker and a speaker control circuit 4 for controlling an operation of the vehicular horn 2.

(Explanation of Vehicular Horn 2)

The vehicular horn 2 is an electromagnetic alarm sound generation device that emits an alarm sound to an area outside of the vehicle. The vehicular horn 2 has a well-known structure, for example. The vehicular horn 2 is arranged at a front part of the vehicle, such as on an inner side of a front grill, so as to emit the alarm sound to the area outside of the vehicle.

Specifically, the vehicular horn 2 emits the alarm sound when a horn switch, such as a horn button of a steering wheel, is operated by a user. The vehicular horn 2 generates the alarm sound when a direct current self excitation voltage equal to or greater than a threshold value (e.g., a voltage equal to or greater than 8 V, such as a battery voltage) is applied.

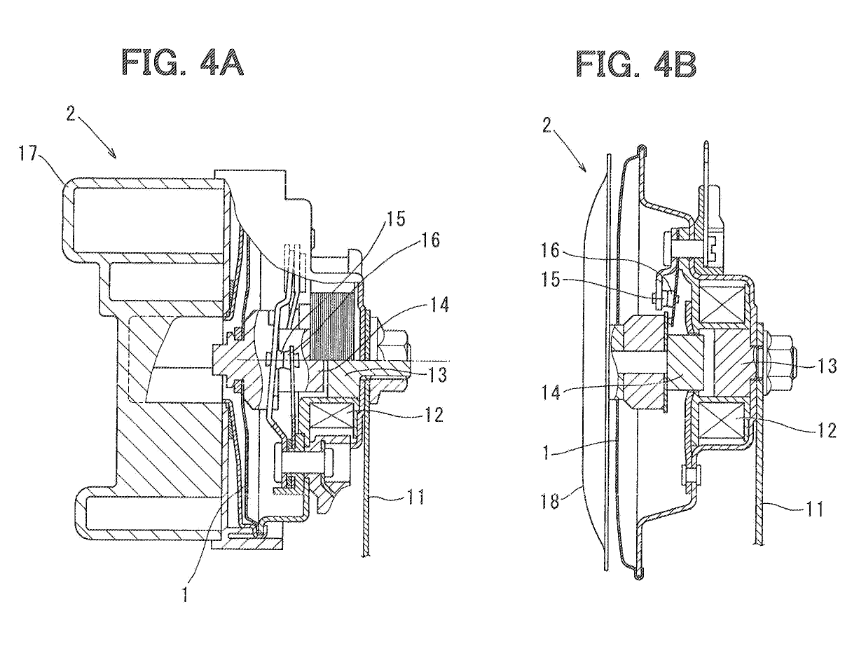

A detailed structure of the vehicular horn 2 will be described with reference to FIGS. 4A and 4B.

The vehicular horn 2 is fixed to the front part of the vehicle through a stay 11. The vehicular horn 2 includes a coil 12, a fixed core (magnetic attraction core) 13, a moving core (movable core) 14, a fixed contact 15 and a moving contact 16.

The coil 12 generates a magnetic force when being applied with an electric current. The fixed core 13 generates a magnetic attraction force due to the magnetic force generated by the coil 12. The moving core 14 is supported at a central portion of a vibration plate (diaphragm) 1 and is movable towards the fixed core 13. The moving contact 16 moves with a movement of the moving core 14. The moving contact 16 separates from the fixed contact 15 with the movement of the moving core 14 toward the fixed core 13, thereby to shut down the electric current to the coil 12.

Application of the direct current self excitation voltage equal to or greater than the threshold value (e.g., equal to or greater than 8V) to current application terminals of the vehicular horn 2 (i.e., terminals connected to both ends of the coil 12) enables the repetition of the following two movements:

(i) an attraction movement where the moving core 14 is attracted toward the fixed core 13 by the magnetic force to separate the moving contact 16 from the fixed contact 15, thereby to shut down the electric current to the coil 12; and

(ii) a restoration movement where the moving core 14 is returned to an initial position due to the vibration plate 1 exerting a force as a return spring to bring the moving contact 16 into contact with the fixed contact 15, thereby to restart the electric current application to the coil 12.

Thus, such an intermittent electric current application to the coil 12 (i.e., intermittent occurrence of the magnetic attraction force of the fixed core 13) causes the vibration plate 1 to vibrate with the moving core 14, resulting in the generation of the alarm sound from the vehicular horn 2.

FIGS. 4A and 4B illustrate examples of the vehicular horn 2. The vehicular horn of FIG. 4A emits an alarm sound that has been amplified through a horn member 17, which has a spiral trumpet shape and serves as an acoustic tube. The vehicular horn of FIG. 4B emits an alarm sound that has been amplified by a resonance plate (disc) 18.

In the present embodiment, the vehicular horn 2 is used as the dynamic speaker for generating the notification sound, as described above. Specifically, when the coil 12 is applied with “the frequency signal (electric signal)” of a separate-excitation voltage (e.g., a voltage lower than 8 V) which is lower than the self-excitation voltage, the vibration plate 1 is vibrated with the coil 12 by “the frequency signal” so as to generate a sound wave (air compression wave) corresponding to “the humming frequency property”.

(Explanation of Speaker Control Circuit 4)

The speaker control circuit 4 includes: a signal generating unit 3 that generates “the frequency signal (electric signal for vibrating the vibration plate 1)”, a horn driving amplifier 21 that drives the vehicular horn 2 by “the frequency signal”; and a signal processing unit 22 that controls generation of the notification sound.

Hereinafter, structure and operation of the speaker signal generating unit 3, the horn driving amplifier 21 and the signal processing unit 22 will be described.

(Explanation of Signal Generating Unit 3)

The signal generating unit 3 stores “the frequency signal” therein beforehand, and outputs “the frequency signal” in accordance with an instruction from the signal processing unit 22. “The frequency signal” generated by the signal generating unit 3 will be described in detail with reference to FIG. 1.

It is desired to include a low pitch tone equal to or lower than 400 Hz (e.g., 250 Hz) in the notification sound, so as to deepen the notification sound and improve comfort to hear.

In a vehicle, since the space for mounting the vehicular horn 2 is generally restricted, it is difficult to increase the size of the vehicular horn 2, which is required to generate the notification sound including the low pitch tone equal to or less than 400 Hz.

In general, the vehicular horn 2 generates the alarm sound having a predetermined frequency (e.g., 500 Hz) as a fundamental tone, and thus is difficult to generate the low pitch tone lower than the fundamental tone. Even if a dynamic speaker, which is separate from the vehicular horn 2, is mounted in a vehicle for generating the notification sound, the space for the separate dynamic speaker is still restricted. Therefore, it is difficult to mount a large speaker such as a woofer. Even if the dynamic speaker separate from the vehicular horn 2 is mounted in a vehicle, it is difficult to generate the notification sound including the low pitch tone equal to or less than 400 Hz.

Because of the above described reasons, in a general technique, the frequency signal is set to equal to or greater than 500 Hz, which can be generated by the vehicular horn 2, as shown in a comparative example (a) in FIG. 1.

To solve such issues, the signal generating unit 3 of the present embodiment employs the following technique.

In the present embodiment, the target regeneration frequency is provided by the A Hz, such as 250 Hz. Here, the target regeneration frequency is a sound that cannot be generated by the vehicular horn 2, but is desired to be generated.

In this case, the signal generating unit 3 is configured to generate “the frequency signal” that has a humming frequency property including “multiple frequencies”. Further, the “multiple frequencies” have an overtone relationship with respect to the A Hz, such as 250 Hz, and are pitched at the A Hz, such as 250 Hz.

The signal generating unit 3 uses a modulation circuit as a signal generating device for generating “the humming frequency property”. That is, “the multiple frequencies” can be outputted by using the modulation circuit.

Specifically, as shown in (b) of FIG. 1, in a range starting from 500 Hz, multiple frequencies are produced every A Hz, such as every 250 Hz, as the humming frequencies. It is to be noted that a dashed line α at 250 Hz in (b) of FIG. 1 is a frequency that is not generated by the signal generating unit 3.

(Explanation of Horn Driving Amplifier 21)

The horn driving amplifier 21 is a power amplifier to operate the vehicular horn 2 as a dynamic speaker. The horn driving amplifier 21 amplifies “the frequency signal” outputted from the signal generating unit 3 and applies the amplified frequency signal to the current application terminal of the vehicular horn 2.

The maximum output power of the horn driving amplifier 21 is limited to less than 8 V (separation-excitation voltage), so as to restrict the vehicular horn 2 from generating the alarm sound due to the voltage output for generating the notification sound.

(Explanation of Signal Processing Unit 22)

The signal processing unit 22 receives a notification sound operation signal (operation instruction signal) for generating the notification sound from an external device, such as an engine control unit (ECU) of the vehicle. For example, the ECU provides the notification sound operation signal to the signal processing unit 22 in the following situations:

(i) when the vehicle is in a predetermined operation condition, that is, in a traveling condition where generation of the notification sound is required, such as, in a condition where the traveling speed is equal to or lower than 20 km/h; and

(ii) when a human is detected in a direction of vehicle travel by a human recognition system (not shown) or the like while the vehicle is traveling.

(Operation and Advantageous Effect of the First Embodiment)

When the signal processing unit 22 receives the notification sound operation signal from the ECU or the like, the signal processing unit 3 outputs “the frequency signal”, which has the humming frequency property including “the multiple frequencies shown in (b) of FIG. 1”, to the horn driving amplifier 21. The horn driving amplifier 21 amplifies “the frequency signal” and transmits the amplified signal to the current application terminal of the vehicular horn 2.

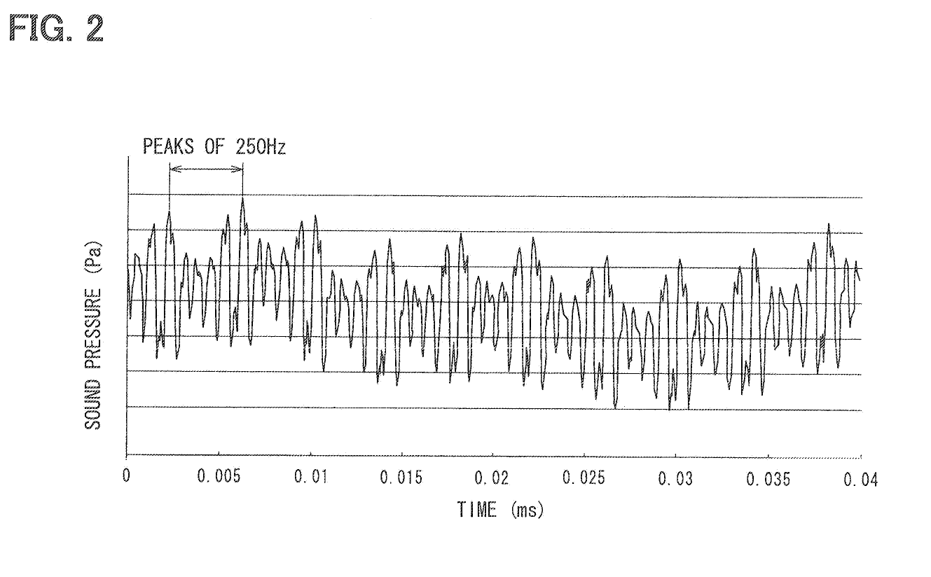

When receiving “the frequency signal”, the vehicular horn 2 produces “a sound wave including multiple humming frequencies” due to vibrations of the vibration plate 1. FIG. 2 illustrates the sound wave produced by the vehicular horn 2.

As shown in FIG. 2, the sound generated by the speaker has a humming property that periodically peaks at the target generation frequency (A Hz), such as “250 Hz”. As a result, “the 250 Hz” is generated as a humming sound.

That is, although “the 250 Hz” is not mechanically produced by the vehicular horn 2, “the 250 Hz” can be heard by the humming property as if “the 250 Hz” is actually generated from the vehicular horn 2. As a result, the notification sound including the “250 Hz” can be produced.

Accordingly, in the vehicle approach notification apparatus, the notification sound including “the 250 Hz”, which is lower than a sound generation limit of the vehicular horn 2, can be emitted to an area outside of the vehicle. That is, the notification sound including the low pitch tone can be produced without mounting a large speaker such as a woofer in a vehicle.

In the present embodiment, since “the multiple frequencies” of the frequency signal are generated using the modulation circuit, the humming property at the intervals of “250 Hz” occurs noticeably. Thus, “the 250 Hz” is generated as a large sound. In other words, the sound pressure of “the 250 Hz” can be produced substantially equal to a sound pressure of “the humming frequency sound wave” which is actually generated by the vehicular horn 2.

### Second Embodiment

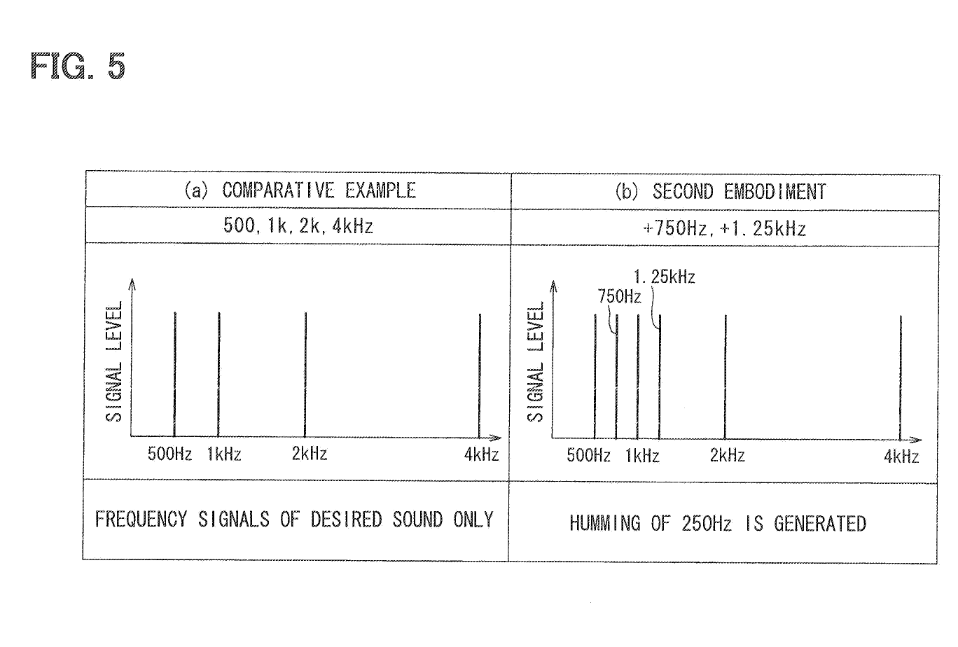

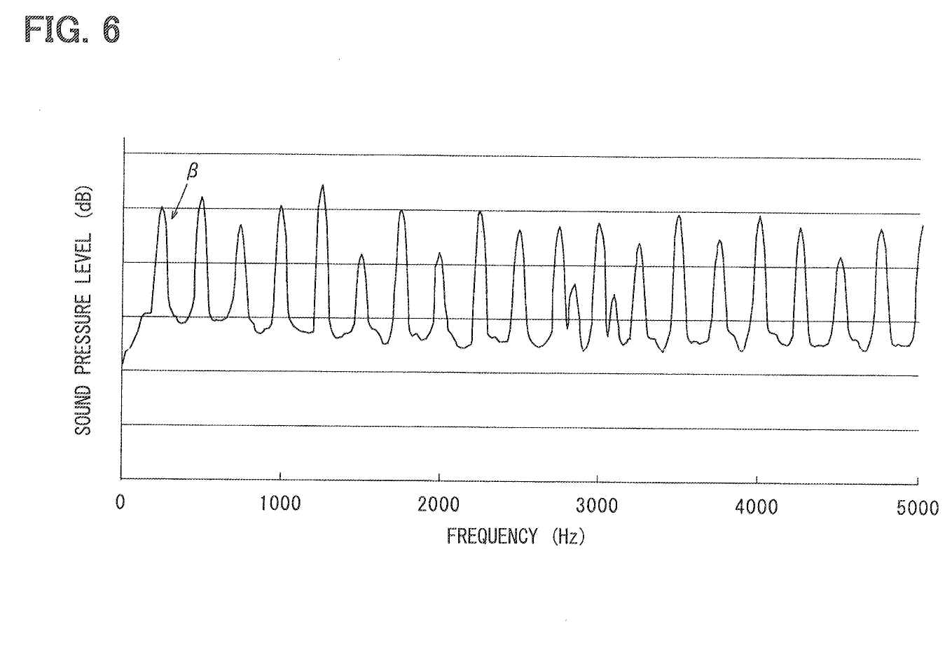

A second embodiment will be described with reference to FIGS. 5 and 6. Hereinafter, like parts are designated with like reference numerals.

The vehicular horn 2, as an example of the dynamic speaker, generates the alarm sound having the fundamental tone of 500 Hz, similar to the first embodiment. Thus, it is difficult to generate a low pitch tone (e.g., 250 Hz) lower than the fundamental tone.

Therefore, in a general technique, for example, to generate the sound of “do” of equal temperament as an example of the notification sound, a frequency signal including frequencies of “do”, which are equal to or higher than 500 Hz generated by the vehicular horn 2 (i.e., frequencies of 500 Hz, 1 kHz, 2 kHz, and 4 kHz) is used, as shown in a comparative example in (a) of FIG. 5.

In the present embodiment, on the other hand, the target generation frequency is provided as “250 Hz (“do” sound that is in an octave lower than 500 Hz) as an example of the A Hz. Therefore, as shown in (b) of FIG. 5, the signal processing unit 3 is configured to output “the frequency signal” having a humming frequency property that includes multiple frequencies having an overtone relationship with respect to 250 Hz and being pitched at 250 Hz.

Specifically, the signal generating unit 3 outputs “the frequency signal” in which frequencies of 750 Hz and 1.25 kHz are added to the frequencies of the “do” sound as shown in (a) of FIG. 5. That is, the humming frequency property of the frequency signal (electric signal) includes the frequencies of 500 Hz, 750 Hz, 1 kHz, and 1.25 kHz, as shown in (b) of FIG. 5.

The horn driving amplifier 21 amplifies “the frequency signal” having the humming frequency property that includes the frequencies of “do” sound and the frequencies of 750 Hz and 1.25 kHz from the signal processing unit 3. When the current application terminal of the vehicular horn 2 is applied with the amplified frequency signal, “the humming frequency property of the frequency signal” is produced by the vehicular horn 2. Thus, “the sound wave having the humming frequency property” is emitted from the vehicular horn 2. As such, the humming sound of 250 Hz is created in a time axis. That is, the sound wave has a periodic property of harmonic at 250 Hz.

As a result, as shown by an arrow 13 of FIG. 6, the “250 Hz”, which is not mechanically generated from the vehicular horn 2, is produced by the humming property as if the “250 Hz” is actually generated from the vehicular horn 2. That is, the “do” sound of 250 Hz, which cannot be generated by the vehicular horn 2, can be produced.

In the above descried exemplary embodiments, the vehicular horn 2 is employed as the example of dynamic speaker. Alternatively, a separate dynamic speaker (microspeaker) may be mounted in the vehicle, separately from the vehicular horn 2, to generate the notification sound.

In the above described exemplary embodiments, the notification sound is generated by the dynamic speaker, such as the vehicular horn 2. As another example, the notification sound may be generated by both of a parametric speaker using ultrasound waves and the dynamic speaker (e.g., the vehicular horn 2).

In the above described exemplary embodiments, the sound wave generator is employed to the vehicle approach notification apparatus. However, the use of the sound wave generator is not limited to the vehicle approach notification apparatus. For example, the sound wave generator may be employed to an alarm sound generator and a ringing tone generator for houses and buildings.

Additional advantages and modifications will readily occur to those skilled in the art. The invention in its broader term is therefore not limited to the specific details, representative apparatus, and illustrative examples shown and described.

What is claimed is:

1. A sound wave generator comprising:
a speaker control circuit that includes a signal generating unit, the signal generating unit being configured to generate an electric signal that has a humming frequency property, the humming frequency property including a plurality of frequencies that have an overtone relationship with respect to A Hz and are pitched at the A Hz, the A Hz being a target generation frequency and corresponding to a low pitch frequency in an audible range; and
a speaker that generates a sound wave from the electric signal by applying the electric signal to a vibration plate that produces the sound wave.

2. The sound wave generator according to claim 1, wherein the signal generating unit includes a modulation circuit to generate the humming frequency property.

3. The sound wave generator according to claim 1, wherein the sound wave generator is disposed in a vehicle approach notification apparatus that notifies a presence of a vehicle by emitting a notification sound to an outside of the vehicle.

4. The sound wave generator according to claim 1, wherein:
the speaker is a vehicular horn including a coil, a moving core, a fixed core and the vibrating plate;
when a direct current self-excitation voltage equal to or higher than a threshold level is applied to the coil, the vibrating plate is vibrated with the fixed core by an intermittent electric conduction to the coil due to the moving core being attracted to the fixed core by a magnetic force generated by the coil, thereby to generate an alarm sound, and
when the electric signal by a separation-excitation voltage lower than the self-excitation voltage is applied to the coil, the vibrating plate is vibrated by the electric signal, thereby to generate the sound wave corresponding to the humming frequency property.
